(19) United States
(12) Patent Application Publication
(10) Pub. No.: US 2015/0129333 A1
(43) Pub. Date: May 14, 2015

(54) Control System and Method for Transport Device

(71) Applicant: TransMotion Medical, Inc., Sharon Center, OH (US)

(72) Inventors: David J. Morris, Novelty, OH (US); Nathan E. Yensho, Norton, OH (US); Dustin J. Sadler, Rittman, OH (US); Robert E. Herchick, Copley, OH (US)

(73) Assignee: TransMotion Medical, Inc., Sharon Center, OH (US)

(21) Appl. No.: 14/079,701

(22) Filed: Nov. 14, 2013

(51) Int. Cl. A61G 1/02; A61G 1/017

(52) U.S. Cl. CPC A61G 1/0275; A61G 1/017; A61G 1/0237
USPC 180/65.8

(57) ABSTRACT

A selectively powered transport device such as an ambulatory stretcher-chair is presented. The stretcher-chair has a spring-biased Hall-effect mechanism controlled by an operator to command a desired direction and speed of mobility of the device. A power drive control unit senses a target direction and speed of movement and incrementally closes on that target. The power drive control unit senses the presence of ramps or inclines by monitoring instantaneous current to a drive motor and adjusts the motor operation accordingly. The power drive control unit further monitors thermal operational conditions of the drive motor by monitoring motor winding current and assessing energy dissipated as heat in the motor winding as a function thereof. The net accumulated heat energy associated with the motor is monitored and corrective action with respect to the current applied to the motor is taken accordingly.

### TECHNICAL FIELD

The invention herein resides in the art of transport devices and, more particularly, battery-powered transport devices employing one or more motor-driven drive wheels. Specifically, the invention relates to an ambulatory transport mechanism comprising a chair, stretcher, or stretcher-chair. The invention is particularly directed to an input device controlled by a user and the associated apparatus and method to respond to the requests of the user through the input device to control the mobility of the unit.

### BACKGROUND OF THE INVENTION

Ambulatory devices for transporting patients and the like have progressed over the years from a manually transported stretcher to wheeled chairs, wheeled stretchers, and wheeled stretcher-chairs. While the earlier embodiments relied upon manual force for mobility, these have given way to powered units, typically driven by battery-powered wheels. These devices have accommodated use by persons not otherwise having sufficient strength to manually power the units. Control units are presently of a very rudimentary nature, and are not given to ready adaptation for use in various environments or for the transporting of various sizes of patients.

Ambulatory transport devices must, in a first instance, be adapted for use in transporting a small child as well as an obese adult. The transport devices must also be given to ease a uniformity of operation over a variety of transport paths, from flat, planar surfaces to inclines and declines, to transitional non-uniformities in the floor surface at thresholds and the like.

There is a need in the art for a control system and associated method of operation for use in association with transport devices, such as ambulatory stretcher-chairs and the like, that accommodates a broad range of both patients and operators to achieve comfortable and effective transport over various flooring surfaces, demonstrating a broad range of elevational and transitional changes. There is a particular need for a transport device in which the control system and associated method can gradually and smoothly accelerate and decelerate, maintain a selected speed, accommodate inclines and declines, as well as transitional surfaces, and operate without undue heat buildup within or adverse impact on the drive motor and control electronics—all while being conducive to patient comfort.

### DISCLOSURE OF INVENTION

In light of the foregoing, it is a first aspect of the invention to provide a control system and method for transport devices, which accommodates any of a broad range of operators.

A further aspect of the invention is the provision of a control system and method for transport devices that accommodates any of a broad range of uses, such as the transport of patients of various height, weight or shape.

Yet another aspect of the invention is the provision of a control system and method for transport devices that includes an operator interface that is easy to use and quickly responsive to operator input.

Another aspect of the invention is the provision of a control system and method for transport devices that operates to ensure smoothness of operation consistent with patient comfort over a broad range of floor characteristics from inclines, declines, ramps, transitional discontinuities, and the like.

Yet an additional aspect of the invention is the provision of a control system and method for transport devices that monitors and controls the speed of the device by monitoring and controlling the voltage and current to the drive motor.

Still another aspect of the invention is the provision of a control system and method for transport devices that monitors motor temperature by monitoring the current to the motor in an integrated fashion over time.

Still another aspect of the invention is the provision of a control system and method for transport devices that is conducive to use and implementation with any of a broad range of transportable mechanisms, such as tables, carts, stretchers, chairs, stretcher-chairs and the like, and which can be readily implemented with state-of-the-art devices and techniques.

The foregoing and other aspects of the invention may be attained by a control system and method for transport devices, wherein a selectively powered transport device comprises a base supporting a motor and at least one drive wheel driven by said motor; a support structure mounted to said base for receiving and maintaining an object to be transported; caster wheels attached to said base, said base being bifurcated into at least two portions, each portion having at least one of said caster wheels attached thereto, said at least two bifurcated portions articulating with respect to each other; and a power drive control unit connected to said motor, said control unit having a user input device receiving commands from a user corresponding to a desired direction and speed of movement of said drive wheel, said input device having a first sensor for responding to actions of the user correlating with said desired direction and speed.

Other aspects of the invention that will become apparent herein may be achieved by a selectively powered transport device, wherein a power drive control unit senses a target direction and speed of movement of a drive wheel and incrementally adjusts an electrical current to the motor of the drive wheel to correspondingly cause movement of the drive wheel to close on the target.

Further aspects of the invention that will become apparent herein may be achieved by a selectively powered transport device wherein a power drive control unit monitors instantaneous current to a drive motor and assesses motor load therefrom, the motor load indicating ramps or inclines engaged by a drive wheel.

Still additional aspects of the invention that will become apparent herein may be achieved by a selectively powered transport device wherein a power drive control unit monitors thermal operational conditions of a drive motor by measuring the motor winding current.

### DESCRIPTION OF DRAWINGS

For a complete understanding of the various aspects and techniques of various embodiments of the invention, reference may be made to the following detailed description and accompanying drawings wherein:

FIG. 1 is an illustrative view of a transport stretcher-chair device representative of the type of devices that may be employed with the invention;

FIG. 2 is a schematic block diagram of the operative system of the invention;

FIG. 3 is a pictorial illustration of the operator drive control mechanism of the invention;

FIG. 4 is a flowchart illustration of the user interface drive employed with the invention;

FIG. 5 is a flowchart illustration of the operation of the Hall-effect sensor system employed in an embodiment of the invention;

FIG. 6 is a flowchart illustration of the motor current compensation system of the invention; and

FIG. 7 is a flowchart illustration of the motor temperature monitoring and protection system of the invention.

### DETAILED DESCRIPTION OF PREFERRED EMBODIMENTS

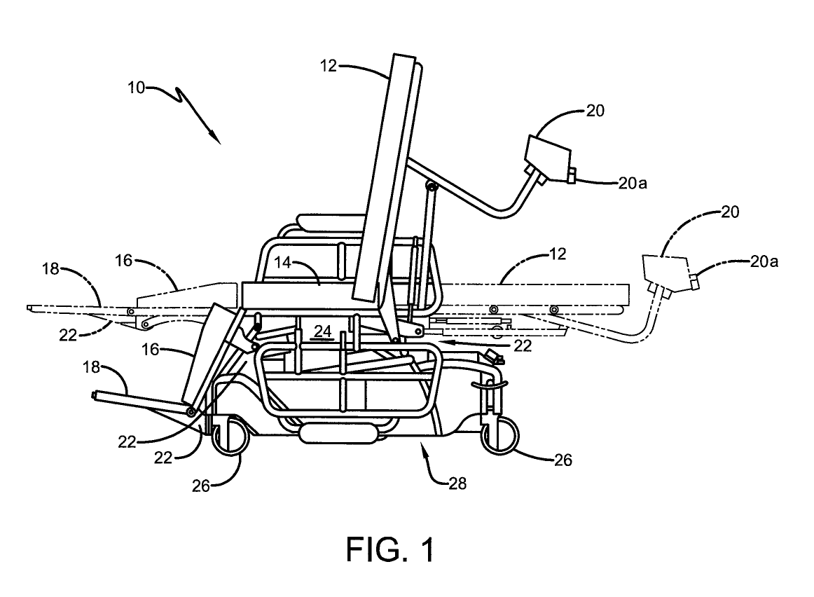

Referring now to the drawings and more particularly FIG. 1, it can be seen that a transport device in the form of an ambulatory stretcher-chair adaptable for use in accordance with the invention is designated generally by the numeral 10. The ambulatory stretcher-chair 10 includes a back 12 hingedly connected to a seat 14 at a first end of the seat, and a leg rest 16 hingedly connected to the seat 14 at an opposite end thereof. A foot support 18 is hingedly connected to the leg rest 16. The hinged connections allow adjustment of the stretcher-chair 10 from a full, upright chair position as shown in solid lines in FIG. 1 to a fully horizontal stretcher position as shown in phantom lines. Of course, any of numerous positions and postures can be attained with the stretcher-chair 10 as a function of the degrees of actuation of the various actuators interconnected with the back 12, leg rest 16 and foot support 18. The actuator 22 may be of any of various types or natures, including stepper motors and linkages and the like.

A keypad assembly 20 is mounted adjacent the back 12 and provides a means of command/data input from an operator. A microchip or other electronic control device may be contained within the keypad assembly 20 for generating and sending control signals to the various actuators, motors and the like as will be apparent later herein. A pair of push handles 20a is appropriately attached for access by the user or operator, typically in association with the back 12 and, as shown in the embodiment of the invention, in attachment with the keypad assembly 20.

A telescopic column lift 24 may be used in connection with the seat 14 to raise and lower the patient-receiving portion of the ambulatory stretcher-chair 10 upon user command. As the seat 14 raises, all of those elements directly or indirectly connected thereto will also raise. The column lift 24 is typically a motor-driven, screw-drive column, but any of various types may be employed.

Caster wheels 26 are provided at each of the four corners of the stretcher-chair assembly 10, and typically have locks associated therewith to render the chair immovable when desired.

The stretcher-chair 10 may also include a bifurcated base housing 28 having at least one drive wheel and associated drive motor with interconnecting gears and shafts. Under operator control, to be discussed herein, the drive wheel causes movement of the ambulatory stretcher-chair 10 over supporting floor surfaces.

While the concept of the invention is adaptable for implementation with any of various types of transport devices, a particular embodiment adaptable for such use is shown in U.S. Pat. No. 8,418,786, assigned to the assignee of the instant application.

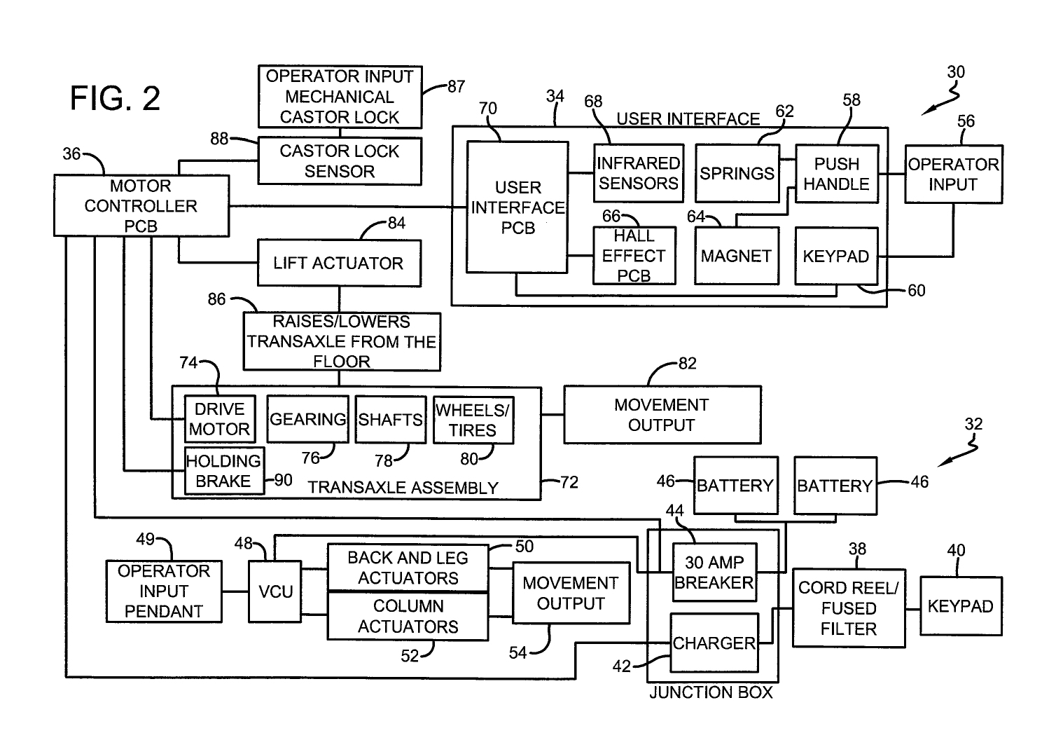

With reference now to FIG. 2, it can be seen that an ambulatory transport control system for a device such as a stretcher-chair is designated generally by the numeral 30. The control system 30 includes a power section 32, a user interface 34, and a motor controller printed circuit board 36 as key structural elements to be described further herein. The control system is preferably battery powered and, in that regard, a cord reel/fused filter 38 is adapted to be connected to an appropriate AC power input 40 to accommodate powering of a charger 42, which, through the motor controller printed circuit board 36 and an appropriate breaker or fuse 44, interconnects with the pair of batteries 46. The batteries 46 provide the primary power for all operation of the stretcher-chair assembly and its mobility.

A controller 48 receives power from the batteries 46 and input commands from an operator-controlled pendant 49 to actuate and control back and leg actuators 50 and column actuators 52 of the ambulatory chair unit. The back and leg actuators 50 are operative to move the stretcher-chair to any of various postures as from an upright chair to a fully horizontal stretcher, and any of various orientations therebetween, dependent upon the positioning of the back and leg rests effected by associated actuators 50. In like manner, the vertical positioning of the stretcher-chair assembly and the vertical orientations thereof, are controlled by the column actuators 52. The actuators 50, 52 effect an appropriate and requested movement output at 54 of the stretcher-chair with regard to vertical positioning as well as its selected orientations. In other words, the operator may, through the user interface and the actuators 50, 52, articulate the back and leg supports of the ambulatory stretcher-chair in selective combinations from full upright to full recline, as well as raising or lowering the vertical height of the stretcher-chair or portions thereof.

The operator input block 56 allows a medical attendant or the like to control the mobility and utility of the stretcher-chair through a push handle 58 and keypad 60. The push handle 58 is employed to control mobility as will become apparent later herein. The keypad 60 allows the inputs of codes, data, identification numbers, and the like to enable the ambulatory stretcher-chair for operation or designated functions. Springs 62 are provided in association with the push handle 58 to give a responsive “feel” to the operator. A magnet 64 is operatively connected to or otherwise associated with the push handle 58 to operate in conjunction with a linear Hall-effect sensor and associated printed circuit board 66. The output of the Hall-effect sensor and printed circuit board 66 is an indication of the position of the push handle 58, biased by springs 62, at any point in time, this positioning being an indication of the request of the user for forward or rearward movement and the desired rate of such movement.

Infrared sensors 68 are also provided as a part of the user interface and emit a signal indicating whether a user is present by monitoring the push handle for the presence or absence of a user's hands.

A user interface printed circuit board 70 communicates with the keypad 60 and the push handle 58 along with its associated Hall-effect system 64, 66 and infrared sensors 68 to emit appropriate control signals to the motor controller printed circuit board 36, those signals corresponding with commands and requests of the operator input 56.

The primary mode of movement of the ambulatory stretcher-chair is a transaxle assembly 72 or other appropriate drive-wheel mechanism. The transaxle assembly 72 includes a drive motor 74 connected through appropriate gearing 76 and drive shaft 78 to one or more drive wheels and associated tires 80. A desired movement output 82 is achieved under control of the drive motor 74 through the motor controller printed circuit board 36 and pursuant to operator demand from the operator input 56 through the user interface 34. The user may also activate a lift actuator 84 to raise or lower the transaxle from engagement with the floor as at 86. An appropriate motor and lift mechanism can be employed for this purpose. It will be understood that it may be desirable to lift the drive wheel or wheels from the floor, once the transporting operation is complete, to allow any further movement of the stretcher-chair to be undertaken by means of caster wheels or the like. When finally positioned in a desired location, the caster wheels may be locked by the operator through a mechanical caster lock 87 or otherwise and, for that purpose, a caster lock sensor 88 may provide a signal to the keypad 60, where a light illuminates to indicate that condition. In like manner, a holding brake 90 of any appropriate type may be provided in association with the transaxle assembly 72 to lock the drive wheel or wheels as selected by the operator input 56 through either the push handle 58 or keypad 60.

Thus, it can be seen that, in general, the operator can control the orientation and manipulation of the stretcher-chair as well as its selected mobility and immobility through the operator input 56 and user interface 34.

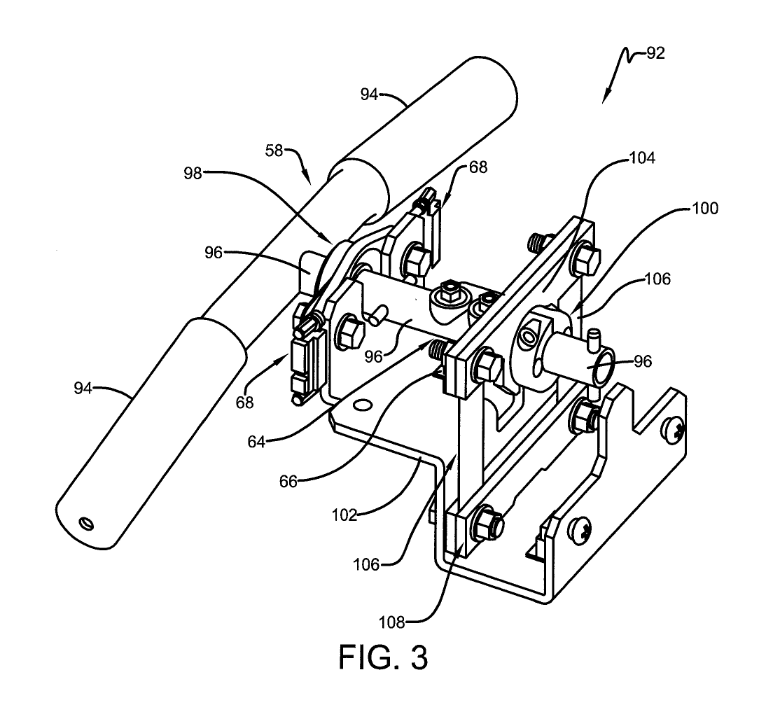

Referring now to FIG. 3, an appreciation may be obtained with regard to the operator drive control unit 92 of the invention. As shown, a pair of handgrips 94 is provided on opposite ends of the push handle 58 to allow for comfortable gripping by an operator. A rod 96 extends substantially orthogonally from the push handle 58 and has mounted thereto the magnet 64 moving in proximity to the Hall-effect printed circuit board 66 to provide an output signal corresponding to the position of the rod 96, handgrips 94, and push handle 58, all of which are a function of operator selection. As shown, the infrared sensors 68 are provided in proximity to the handgrips 94 to sense the presence of a hand or hands of an operator. Of course, the presence of an operator is necessary for most all of the functions of the control system herein.

A fixed bracket 102 receives and maintains the collar 108, while a mounting bracket 104 is adapted to receive the collar 100. The bracket 104 is mounted to the fixed bracket 102 by means of leaf springs 106, as shown. A brace bracket 108 secures the leaf springs 106 to the fixed bracket 102, as shown.

It will be appreciated from the operator drive control assembly 92 as shown in FIG. 3 that the infrared sensors sense the presence of an operator at the handgrips 94 to enable operation. The handgrips 94 are mounted on the push handle 58, which is spring biased as by the leaf springs 106 through the rod 96 mounted between the bushing 98 and collar 100. Movement of the push handle 58 and associated rod 96 controls the position of the magnet 64 with respect to the Hall-effect sensor 66 as to the demand or request of the operator for more or less speed of the unit or energy to the motor 74, as well as the direction of such movement.

The invention contemplates a variety of mechanisms for satisfying the function of the drive control assembly 92. The assembly just described may also employ a handle that an operator may twist, rotate, turn, pivot or squeeze in association with appropriate sensors such as potentiometers, strain gauges, and the like to produce control signals correlating with desired direction and speed of movement. All could, of course, be appropriately biased to a neutral position as described above. That biasing may be appropriately achieved as by mechanical springs, elastomeric elements, viscous damping, magnetic fields and the like.

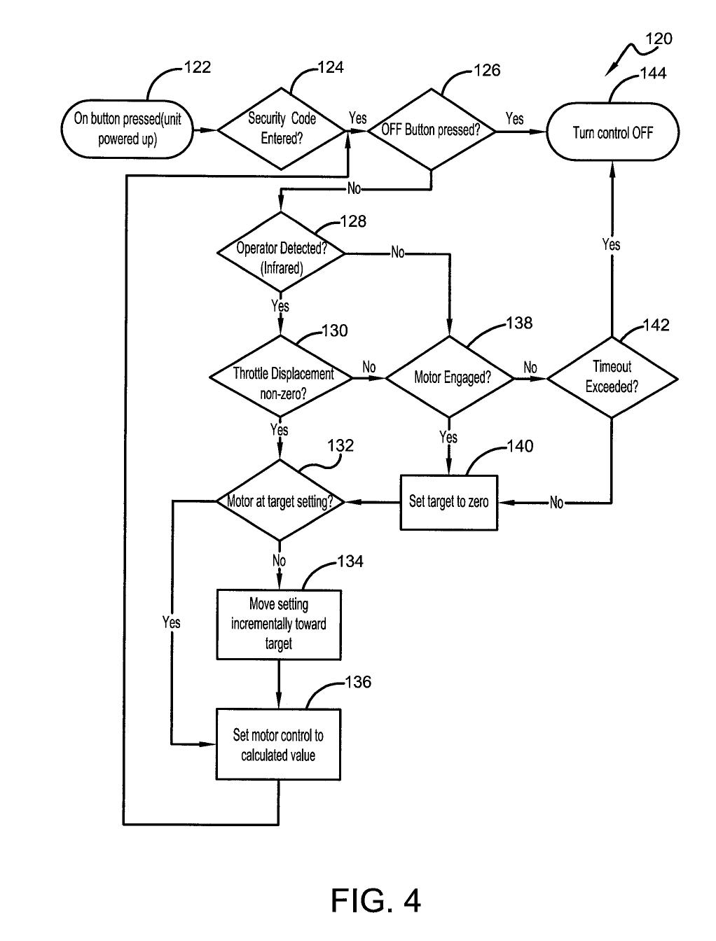

With an appreciation of the physical structure of the ambulatory transport control device and system of the invention, consideration shall now be given to the various processes, techniques and methods employed thereby. With reference now to FIG. 4, it can be seen that the process of the user interface 34 is designated generally by the numeral 120. To begin, an “on” button associated with the keypad 60 or otherwise, is actuated by the operator at 122, and a security code entered on the keypad 60 at 124. Once the security code has been entered, a determination is made at 126 as to whether the “off” button has been pressed or actuated. If it has been actuated, the controls of the entire system are turned off as at 144. If, however, the “off” button has not been actuated, a determination is made at 128 by means of the infrared sensors 68 as to whether or not an operator is present, as determined by the presence of the operator's hand(s) on handgrip(s) 94. If the operator is detected as being present, an assessment is then made as to the throttle displacement as monitored by the Hall-effect system 64, 66 at 130. If there is a throttle displacement, a determination is made at 132 as to whether the wheel drive motor is at a target setting as determined by the Hall-effect system 64, 66. If it is not, the motor setting is incrementally moved toward the target established by the Hall-effect system 64, 66 as at 134. At 136, the motor control is set to the calculated target value at 136 and the loop continues back to 128 to either maintain the target setting to ensure smooth motion, or to augment it as requested by the user.

If it is determined at 128 that an operator is not present, or if it is determined at 130 that throttle displacement is zero, the determination is made at 138 as to whether the motor is engaged. If it is, action is taken at 140 to set the motor target to zero to ensure that the motor does not drive the drive wheels.

If a determination is made at 138 that the operator is not present and the motor is not engaged, a timing sequence is entered at 142. The timing sequence is set to an amount of time to accommodate a user removing his/her hands from the handgrips 94 for a short period of time and then returning for continued use. This amount of time is generally set in the range of 2-3 seconds in the event of a software failure and 3-15 seconds for a hardware failure. Until a time limit has been reached, the motor target is set to zero at 140 and the motor is allowed to slow down to that target through 132-136. When the operator is detected again at 128 and the throttle is engaged at 130, the normal processing of motor control is reentered. In the event the timer times out at 142 without an operator present, the system controls are shut down as at 144.

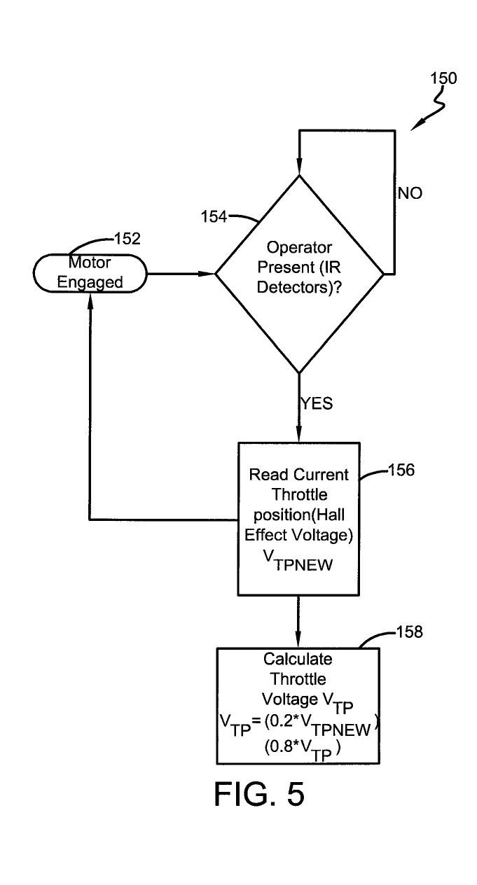

With reference now to FIG. 5, it can be seen that the process engaged by the Hall-effect sensor system 64, 66 is designated generally by the numeral 150. This process seeks to determine the presence of an operator and the position of the throttle, which is effectively the position of the rod 96 connected to the handgrips 94 of the push handle 58. This position is determined by the Hall-effect sensor 66 and associated magnet 64. As shown in FIG. 5, when the motor is engaged, as shown at 152, a determination is made at 154 as to whether an operator is present as determined by the infrared sensors 68. When an operator is present and the motor is engaged, the current throttle position, determined by the Hall-effect system, is determined at 156 and an associated throttle voltage to be applied to the wheel drive motor is determined at 158. This process continues through the loop of the process of FIG. 5, accommodating changes in throttle position by the user and operator, and continually converting throttle position to voltage.

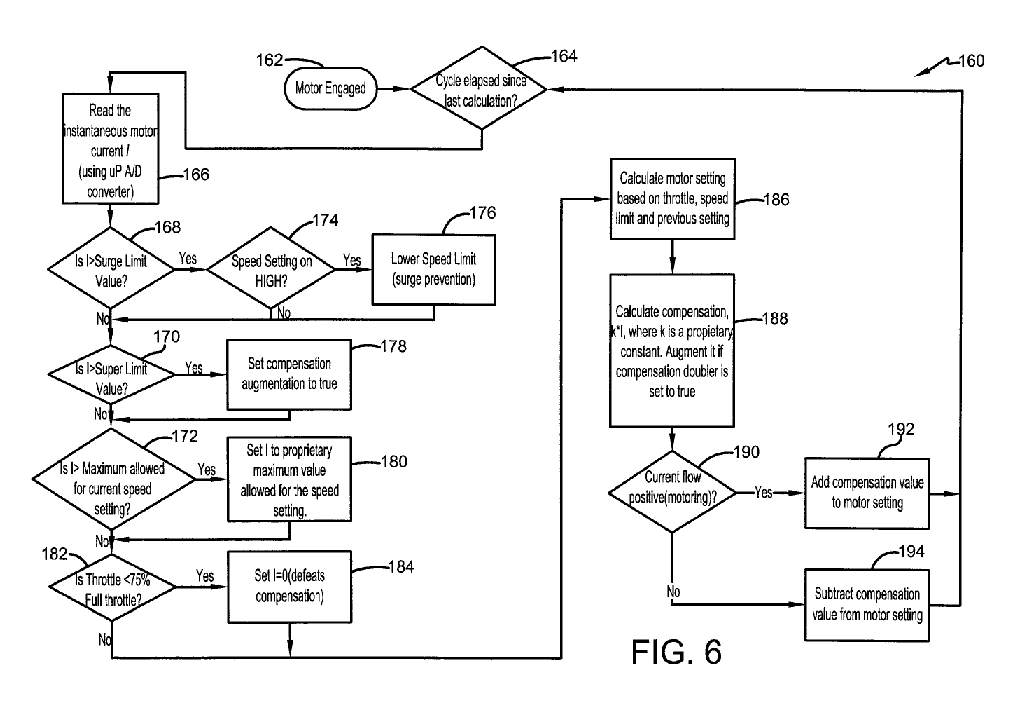

With reference now to FIG. 6, the processing flowchart for load compensation motor control can be seen as designated generally by the numeral 160. This method employs a closed-loop operation based on measuring current to the wheel drive motor to regulate and control speed, because there is no tachometer or speedometer associated with the ambulatory transport device. It is known that motor current increases with the load placed on the motor and, accordingly, compensation must be made for any given load or variation thereof to ensure smooth, uniform and consistent operation.

As shown, the drive motor is engaged at 162 as through the Hall-effect system 64, 66. Functional block 164 then controls the rate at which the process 160 is engaged. For example, block 164 may be a timer activating the process at a set frequency, such as every 500 microseconds, 5 milliseconds, or the like. The process then commences with a reading of the instantaneous motor current at 166. That instantaneous motor current is then compared against a first highest current threshold, related to surges and the like, at 168, a middle current threshold corresponding to the highest current level to be experienced by the motor apart from surges at 170, and a lower threshold corresponding to the maximum current allowed for the present speed setting, as set at 172.

In the event the motor current exceeds the highest level (associated with surges) at 168, a determination is made at 174 as to whether the present speed setting is on “high,” in which case the speed limit setting is lowered as at 176 to protect the breaker 44 by limiting the battery current.

If the instantaneous motor current is greater than the second level, as at 170, a compensation augmentation is activated at 178. As will become apparent directly below, this augmentation of the current compensation to be added or subtracted from the motor current serves to compensate for a change in load, be it either as a result of a change in mass being transported or the surface over which the transporting is being made.

At 172, if the current is above a maximum level or threshold for that allowed for the present speed setting, the current is set at 180 to a maximum value allowed for that speed setting.

After the threshold assessments of 168-172 and the adjustments 174-180 associated therewith, a determination is made at 182 as to the position of the throttle or Hall-effect assembly 64, 66. This determination is made at 182, and if the throttle is less than a set percentage of full throttle, the motor current compensation is set to zero at 184, eliminating motor current adjustment or compensation since full throttle has not yet been reached. In other words, a certain amount of throttle remains for use by the operator. If the throttle has been deployed in excess of the threshold set at 182, or if it is less than that threshold and the motor compensation setting has been set to zero at 184, a calculation of the desired motor current setting is made based upon throttle position, the speed limit setting, and the immediately previous setting at 186. At 188, a current compensation factor is made by multiplying a constant times the motor current. If the compensation augmentation is set to “true” or “on” at 178, that compensation value is augmented.

At 190, a determination is made as to whether the motor is operating as a motor or a generator. It will be understood that a transport device moving down a grade may act as a generator with a back EMF. If the current flow is positive, indicating operation as a motor, the compensation factor is added to the motor setting to accommodate an increase in current to the motor, typically necessitated by the motor load at 192. By the same token, if the current flow is negative, the compensation factor is subtracted from the motor setting at 194 indicating that the motor is operating as a generator, such as when going down a declining surface or the like.

The process then renews as at 164. The process repeats itself at a high frequency to ensure sufficient current to the motor to accommodate the loads being encountered, while controlling current surges and minimizing excessive current.

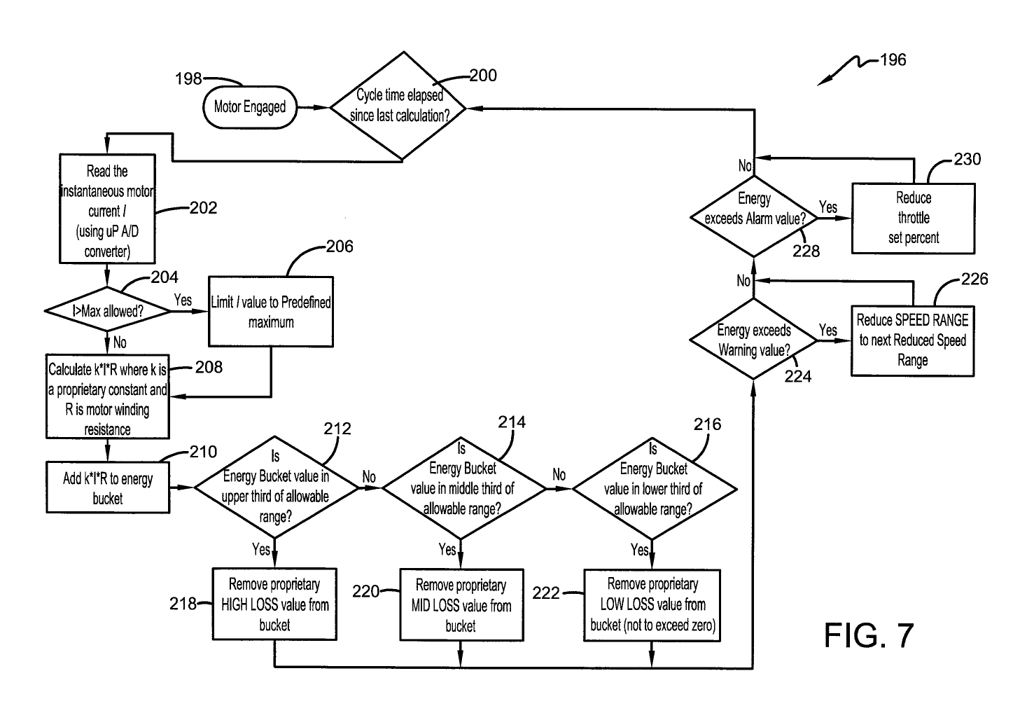

With reference now to FIG. 7, a method for monitoring the operational condition of the motor is shown. Particularly with an electrical motor, of primary concern is the ability to limit the operational temperature of the motor at any point in time. It will be appreciated by those skilled in the art that as the motor current increases, the heat generated in the motor winding also increases as a function of the current value squared. Electrical energy dissipated in the motor windings follows the general rule of E=I²R where E is energy, I is motor current, and R is the motor winding resistance. Much of this energy is dissipated in the form of heat. As the motor windings heat up, the motor efficiency drops off significantly and motor damage may occur. Accordingly, it is desired to operate the motor below a thermal threshold. The methodology of FIG. 7 seeks to do this. As shown, the method designated generally by the numeral 196 begins at 198 where the motor is energized or engaged. At 200, a processing frequency is set for the repetition of the process to be described. That frequency may be on the order of 1-20 milliseconds, although the frequency may vary as system parameters dictate.

After the process is entered at 200, the instantaneous motor current value is read at 202 and a determination is made at 204 whether the motor current exceeds a maximum value allowed. If it does, the current value is limited to a predefined maximum at 206. At 208, the actual current value or the predefined maximum value is used to calculate the energy generated through the motor windings according to the formula E=kI²R where k is a constant value associated with a particular motor. The value of k can be selected for purposes of scaling or the like.

At 210, the energy calculated at 208 is added to or integrated with a summation value of energy from immediately prior passes through the process 196. This summation or integration of energy is, at a point in time, indicative of the heat buildup in the motor. This value of heat energy is then evaluated at 212, 214, 216 as to its level of quantification. Assessment block 212 determines if the heat energy value lies in the upper third of an allowable range; 214 determines if the heat energy lies in a middle third of an allowable range; and 216 assesses whether the heat energy lies in a lower third of an allowable range. Associated with the motor is a cooling characteristic, associated with the construction of the motor, heat sinks, cooling vanes, and the like. Accordingly, as heat is being built up in the motor, it is also being dissipated from the motor by these various means. The reduction of heat is accounted for in depletion blocks 218, 220, 222. If the heat energy lies in the upper third of the allowable range as at 212, that heat energy value is reduced at 218 by a “high loss value” associated with that range. Similarly, if the heat energy lies in the middle third of the allowable range as at 214, a different depletion or reduction occurs at 220 and, similarly, for the function blocks 216, 222. Accordingly, the integrated heat value or net accumulated heat energy associated with the motor at any point in time is a function of the amount of heat energy generated by the current through the motor coils and the amount of heat dissipated by the heat-dissipating characteristics of the motor itself. This heat energy value is applied to decision block 224 where it is determined whether the heat energy exceeds a first warning value. If it does, the speed is reduced to the next reduced speed range at 226. If it does not exceed the warning value, or after reduction is made at 226, a determination is made at 228 as to whether the heat energy exceeds an alarm value. If it does, the throttle is reduced by a set percent as at 230.

After the adjustments at 226, 230, or in the event that the heat energy value exceeds neither an alarm or warning value, the process is reengaged at 200 at a set frequency of repetitions.

Thus, it can be seen that the various aspects of the invention have been achieved by the structure, methods and processes set forth above. While in accordance with the patent statutes, only the best known and preferred embodiments of the invention have been presented and described in detail, it is to be understood that the invention is not limited thereto or thereby. Accordingly, for an appreciation of the true scope and breadth of the invention, reference should be made to the following claims.

What is claimed is:

1. A selectively powered transport device, comprising
a base supporting a motor and at least one drive wheel driven by said motor;
a support structure mounted to said base for receiving and maintaining an object to be transported;
caster wheels attached to said base; and
a power drive control unit connected to said motor, said control unit having a user input device receiving commands from a user corresponding to a desired direction and speed of movement of said drive wheel, said input device having a first sensor for responding to actions of the user correlating with said desired direction and speed.

2. The selectively powered transport device according to claim 1, wherein said input device is biased to a neutral position by means taken from the group of springs, elastomeric elements, viscous damping and magnetic fields.

3. The selectively powered transport device according to claim 2, wherein said input device further comprises a second sensor for monitoring a presence or absence of an operator.

4. The selectively powered transport device according to claim 1, wherein said first sensor comprises a Hall-effect sensor.

5. The selectively powered transport device according to claim 4, wherein said input device comprises a push handle connected to a rod, and wherein said first sensor comprises said Hall-effect sensor in operative communication with said rod.

6. The selectively powered transport device according to claim 5, wherein said rod is biased to a neutral position by a spring, said rod being movable through said neutral position in axially opposed directions.

7. The selectively powered transport device according to claim 6, wherein said input device further comprises an optical detector adjacent said push handle and detecting an absence or presence of an operator's hand.

8. The selectively powered transport device according to claim 7, wherein said optical detector comprises an infrared sensor.

9. The selectively powered transport device according to claim 1, wherein said power drive control unit senses a target direction and speed of movement of said drive wheel and incrementally adjusts an electrical current to said motor to correspondingly cause said movement of said drive wheel to close on said target.

10. The selectively powered transport device according to claim 9, wherein said power drive control unit is inhibited from operation in the sensed absence of an operator engaging said user input device.

11. The selectively powered transport device according to claim 1, wherein said power drive control unit monitors instantaneous current to said motor and assesses motor load therefrom, said motor load indicating ramps or inclines engaged by said drive wheel.

12. The selectively powered transport device according to claim 11, wherein said power drive control unit adjusts motor current to compensate for assessed motor load, said adjustment of motor current ensuring smooth acceleration and deceleration on the ramps and inclines.

13. The selectively powered transport device according to claim 12, wherein said instantaneous motor current is measured against preset thresholds and motor current augmentations are made as a function thereof.

14. The selectively powered transport device according to claim 13, wherein assessment is also made of said commands from a user through said user input device and said motor current augmentations are further a function thereof.

15. The selectively powered transport device according to claim 1, wherein said power drive control unit monitors said motor for thermal operational conditions by measuring motor winding current.

16. The selectively powered transport device according to claim 15, wherein said power drive control unit regulates motor winding current as a function of said thermal operational conditions in a closed-loop mode.

17. The selectively powered transport device according to claim 16, wherein said power drive control unit monitors energy dissipated as heat in windings of the motor and correlates such energy with a temperature of the motor.

18. The selectively powered transport device according to claim 17, wherein said energy dissipated as heat is integrated over time, such that a net accumulated heat energy associated with said motor at points in time is known.

19. The selectively powered transport device according to claim 18, wherein said net accumulated heat energy is compared against threshold values.

20. The selectively powered transport device according to claim 19, wherein said power drive control unit adjusts motor winding current as a function of said comparison of said net accumulated heat energy with said threshold values.
